(19) United States
(12) Patent Application Publication
(10) Pub. No.: US 2025/0096254 A1
(43) Pub. Date: Mar. 20, 2025

(54) LITHIUM BATTERY POSITIVE MATERIAL AND MANUFACTURING METHOD THEREOF

(71) Applicant: NAN YA PLASTICS CORPORATION, Taipei City (TW)

(72) Inventors: Te-Chao Liao, Taipei City (TW); Wei-Sheng Cheng, Taipei City (TW); Chia-Shan Chang, Taipei City (TW); Yu-Chi Hsieh, Taipei City (TW)

(73) Assignee: NAN YA PLASTICS CORPORATION, Taipei City (TW)

(21) Appl. No.: 18/494,778

(22) Filed: Oct. 26, 2023

(30) Foreign Application Priority Data
Sep. 15, 2023 (TW) 112135230

(51) Int. Cl. H01M 4/505; H01M 4/02

(52) U.S. Cl. CPC H01M 4/505; H01M 2004/021; H01M 2004/028

(57) ABSTRACT

A lithium battery positive material includes lithium nickel manganese oxide (LNMO) doped with copper, titanium, nitrogen, and carbon. In addition, a manufacturing method of the lithium battery positive material is also provided.

### CROSS-REFERENCE TO RELATED APPLICATION

This application claims the priority benefit of Taiwan application serial no. 112135230, filed on Sep. 15, 2023. The entirety of the above-mentioned patent application is hereby incorporated by reference herein and made a part of this specification.

### BACKGROUND

### Technical Field

The disclosure relates to a lithium battery positive material and a manufacturing method thereof.

### Description of Related Art

At present, a lithium nickel manganese oxide material has a three-dimensional large tunnel structure, has good conductivity, and is very suitable for diffusion of lithium ions. Therefore, attempts have been made to use it as the positive material for lithium batteries. However, due to its low specific discharge capacity, the costs increase significantly. Thus, how to effectively improve the positive material for lithium batteries, increase the specific discharge capacity, and thereby reduce the costs has been a challenge.

### SUMMARY

The disclosure provides a lithium battery positive material and a manufacturing method thereof, which effectively increase the specific discharge capacity and thereby reduce the costs.

A lithium battery positive material according to the disclosure includes lithium nickel manganese oxide doped with copper, titanium, nitrogen, and carbon.

In an embodiment of the disclosure, a weight ratio of lithium nickel manganese oxide: copper/titanium: nitrogen/carbon in the lithium nickel manganese oxide doped with copper, titanium, nitrogen, and carbon ranges from 1:0.4:0.1 to 1:0.1:0.1.

In an embodiment of the disclosure, an average particle size of the lithium nickel manganese oxide doped with copper, titanium, nitrogen, and carbon is 0.5 microns to 20 microns.

A manufacturing method for manufacturing a lithium battery positive material according to the disclosure includes at least the following. A copper source, a titanium source, and lithium nickel manganate powder are used to form a precursor of lithium nickel manganese oxide doped with copper and titanium by performing a co-precipitation method, a filtration process, and a sintering process. The precursor of the lithium nickel manganese oxide doped with copper and titanium is mixed with a carbon source, and a nitrogen source is coated by a supercritical fluid extraction method to obtain the lithium nickel manganese oxide doped with copper, titanium, nitrogen, and carbon.

In an embodiment of the disclosure, the copper source includes copper chloride, copper sulfate (CuSO₄), copper sulfite (Cu₂SO₄), copper nitrate, copper acetate, or a combination thereof.

In an embodiment of the disclosure, the titanium source includes titanium chloride, titanium sulfate, titanium nitrate, or a combination thereof.

In an embodiment of the disclosure, the nitrogen source includes dopamine, p-phenylenediamine, or a combination thereof.

In an embodiment of the disclosure, the carbon source includes graphene, glucose, or a combination thereof.

In an embodiment of the disclosure, a co-precipitation agent used in the co-precipitation method includes water, ethanol, isopropyl alcohol, acetone, methyl ethyl ketone, ammonia, sodium hydroxide, sodium carbonate, or a combination thereof. A co-precipitation reaction temperature in the co-precipitation method ranges from room temperature (25° C.) to 100° C., and a co-precipitation reaction time in the co-precipitation method ranges from 1 minute to 30 minutes.

In an embodiment of the disclosure, a temperature of the sintering process ranges from 400° C. to 1000° C.

Based on the above, at least one embodiment of the disclosure improves the energy density of the lithium nickel manganese oxide material and solves the problem of low specific discharge capacity with copper-titanium-nitrogen-carbon doping technology. Therefore, the lithium battery positive material of the disclosure effectively increases the specific discharge capacity and thereby reduces the costs.

### DETAILED DESCRIPTION OF DISCLOSED EMBODIMENTS

For purposes of illustration rather than limitation, the following detailed description sets forth exemplary embodiments disclosing specific details to provide a thorough understanding of various principles of the disclosure. However, it should be apparent to those skilled in the art that, with the benefit of this disclosure, the disclosure may be implemented in other embodiments that depart from the specific details disclosed herein. Additionally, the description of well-known devices, methods, materials, and other specific details may be omitted so as not to obscure the various principles of the disclosure.

Throughout this specification, the range expressed by “one value to another value” is a summary expression for avoiding enumerating all the values in the range one by one in the specification. Therefore, the recitation of a specific numerical range covers any value within that numerical range and any smaller numerical range bounded by values within that numerical range, as said any value and smaller numerical range are written in the specification.

Unless otherwise specified, the term “ranges from” used in this specification to define a numerical range is intended to cover a range equal to and between the endpoint values listed. For example, “a size range ranges from a first value to a second value” means that the size range may cover the first value, the second value, and any value between the first value and the second value.

In this specification, non-limiting terms (such as may, can, for example, or other similar terms) refer to non-essential or optional implementation, inclusion, addition, or existence.

Unless otherwise defined, all the terms (including technical and scientific terms) used herein have the same meanings as terms commonly understood by those skilled in the art. It should also be understood that the terms (such as those defined in commonly used dictionaries) should be construed to have meanings consistent with those in the relevant technical context, and should not be interpreted in an idealized or overly formal sense unless expressly defined as such herein.

In this embodiment, the lithium battery positive material includes lithium nickel manganese oxide (LNMO) doped with copper (Cu), titanium (Ti), nitrogen (N), and carbon (C). Accordingly, the disclosure improves the energy density of the lithium nickel manganese oxide material and solves the problem of low specific discharge capacity with copper-titanium-nitrogen-carbon doping technology. In this way, the lithium battery positive material of the disclosure effectively increases the specific discharge capacity and thereby reduces the costs. Here, the weight ratio of lithium nickel manganese oxide: copper/titanium: nitrogen/carbon in the lithium nickel manganese oxide doped with copper, titanium, nitrogen, and carbon is 1:0.4:0.1 to 1:0.1:0.1, and the average particle size of the lithium nickel manganese oxide doped with copper, titanium, nitrogen, and carbon is, for example, 0.5 microns (μm) to 20 microns. Here, copper/titanium represents the total proportion of copper elements and titanium elements in the lithium nickel manganese oxide doped with copper, titanium, nitrogen, and carbon, and nitrogen/carbon represents the total proportion of nitrogen elements and carbon elements in the lithium nickel manganese oxide doped with copper, titanium, nitrogen, and carbon.

A manufacturing method for manufacturing the lithium nickel manganese oxide doped with copper, titanium, nitrogen, and carbon according to the disclosure may at least include: using a copper source, a titanium source, and lithium nickel manganate powder to form a precursor of lithium nickel manganese oxide doped with copper and titanium by performing a co-precipitation method, a filtration process, and a sintering process (first stage); and mixing the precursor of the lithium nickel manganese oxide doped with copper and titanium with a carbon source, and coating a nitrogen source by a supercritical fluid extraction method to obtain the lithium nickel manganese oxide doped with copper, titanium, nitrogen, and carbon (second stage).

Each step of the manufacturing method of the lithium nickel manganese oxide doped with copper, titanium, nitrogen, and carbon in an embodiment of the disclosure will be explained hereinafter.

### Synthesis of Lithium Nickel Manganate Powder

Step 1: a nickel source, a manganese source, and a polymerizing agent are co-precipitated and synthesized to obtain a Ni_{0.5}Mn_{1.5}O₄ precursor, which is then washed and dried to obtain powder, and the obtained powder is calcined to obtain an pre-calcined precursor; step 2: a lithium source, a dopant, and an organic medium are added to the pre-calcined precursor obtained in step 1 to form a stable slurry; and step 3: the powder obtained by atomizing and drying the slurry in step 2 is calcined to obtain powder of the pre-calcined sample LiNi_{0.5}Mn_{1.5}O₄.

In some embodiments, the nickel source is nickel salt (such as nickel sulfate, nickel

nitrate, and nickel acetate), the manganese source is manganese salt (such as manganese sulfate, lithium manganese nitrate, manganese acetate, and manganese chloride), and the lithium source is lithium salt (such as lithium sulfate, lithium carbonate, and lithium chloride); solvent is such as distilled water.

In some embodiments, the specific preparation method is as follows.

First, water is added into laboratory glassware to form a reaction solution. Manganese sulfate is gradually added to the aforementioned solution, which is then stirred by a three-dimensional mixer, shaker, or magnetic stirrer to be mixed thoroughly.

Next, 41.83 g (0.168 mol) of nickel acetate (Ni(CH₃COO)₂·4H₂O) and 10.38 g (0.06 mol) of manganese acetate (Mn(CH₃COO)₂) are dissolved in 228 ml of ethylenediamine according to the molar ratio of the elements of 1:2.8. The total concentration of metal ions is 1.0 M. 27.5 g (0.458 mol) of urea is added according to the molar ratio of urea to metal ions of 2:1, and stirred magnetically for 30 minutes. This mixed solution is stirred magnetically for 2 hours and then transferred to a reaction tank, reacts at 80° C. to 170° C. for 10 hours, and cools to the room temperature naturally. The obtained solution centrifugally precipitates in a centrifuge at a rotation speed of 10,000 RPM, and the upper clear washing liquid is removed. Then, the precipitate is washed with water and dried in an oven at 120° C. After drying, a Ni_{0.25}Mn_{0.75}CO₃ precursor is obtained.

Further to the above, the obtained Ni_{0.25}Mn_{0.75}CO₃ precursor is first sintered at 400° C. to 700° C. for 3 hours, and then mechanically mixed with LiOH·H₂O by a three-dimensional mixer according to Li:(Ni+Mn)=1.05:2 (molar ratio). After being mixed evenly, the obtained mixture is calcinated constantly at 600° C. to 800° C. in the air for 12 hours, and then heated to 800° C. to 1000° C. and sintered for 10 hours. After natural cooling and grinding, the LiNi_{0.5}Mn_{1.5}O₄ positive material is obtained. That is, lithium nickel manganate powder is obtained. Here, all the diffraction peaks of the X-ray diffraction pattern of the LiNi_{0.5}Mn_{1.5}O₄ positive material are consistent with the diffraction peaks of the standard LiNi_{0.5}Mn_{1.5}O₄ (JCPDS card number 80-2162), which shows that the sample has a cubic spinel structure, Fd-3m space group, and each diffraction peak is strong and sharp, indicating that the material is well crystallized and no LiₓNi₁₋ₓO impurity phase is present.

Step 4: infiltration, doping, and modification are performed on the pre-calcined sample obtained in step 3, which is then calcined and screened to obtain LiNi_{0.5-y-x}Mn_{1.5-y-x}CuₓTi_{y}O₄ powder; 0<x+y≤0.1, x>0, y>0. The specific preparation method is as follows.

A copper source, a titanium source, and the lithium nickel manganate powder are used to form a precursor of lithium nickel manganese oxide doped with copper and titanium by performing a co-precipitation method, a filtration process, and a sintering process.

First, a co-precipitation method is performed to add a copper source and a titanium source to the lithium nickel manganate powder for even mixing. The copper source includes copper chloride, copper sulfate, copper sulfite, copper nitrate, copper acetate, or a combination thereof. The titanium source includes titanium chloride, titanium sulfate, titanium nitrate, or a combination thereof. A co-precipitation agent used in the co-precipitation method includes water, ethanol, isopropyl alcohol, acetone, methyl ethyl ketone, ammonia, sodium hydroxide, sodium carbonate, oxalic acid, or a combination thereof. The co-precipitation reaction temperature in the co-precipitation method ranges from room temperature (such as 25° C.) to 100° C. The co-precipitation reaction time in the co-precipitation method ranges from 1 minute to 30 minutes.

Furthermore, a specific embodiment of the co-precipitation method is to mix the aforementioned material in a solvent (water) to obtain a 2M metal solution, stir to suspend the corresponding material, and then add a solvent at the ratio of 1:1 to the aforementioned material to precipitate the material based on the characteristics that the LiNi_{0.5}Mn_{1.5}O₄ precursor and the dopant are insoluble in the solvent (IPA, MEK, methanol, toluene).

Next, a filtration process is performed to remove the solvent (for example, water) of the precursor of lithium nickel manganese oxide doped with copper and titanium and take out the solid part. A sintering process is performed to complete the lattice rearrangement, and copper and titanium are added to the lattice of nickel manganese oxide to obtain a precursor of lithium nickel manganese oxide doped with copper and titanium. Here, the sintering process may be a high-temperature sintering process ranged from a temperature of 400° C. to 1000° C., but the disclosure is not limited thereto. In addition, in calcining, the time of the sintering process may range from 6 hours to 24 hours, and the sintering atmosphere is air or an oxygen atmosphere (oxygen is 99.99% pure oxygen, and air is a general atmospheric environment).

It should be noted that by controlling the co-precipitation agent, the co-precipitation

reaction temperature and co-precipitation reaction time, the sintering process temperature, etc., the particle size of the powdery precursor may range from 0.5 μm to 20 μm. In addition, since the lithium nickel manganate powder is doped with copper and titanium, the interaction between inactive elements in the electronic configuration of titanium and manganese metal ions (Mn⁴⁺, Ti⁴⁺) may effectively provide structural stability during the cycle, and the interaction between nickel metal ions (Ni²⁺) and copper metal ions (Cu²⁺) effectively provides high-potential capacity during the cycle. Therefore, the doping of copper and titanium in the disclosure further improves the performance of lithium batteries in terms of structure and capacity.

The precursor of lithium nickel manganese oxide doped with copper and titanium is mixed with a carbon source, and coated with a nitrogen source by a supercritical fluid extraction method to obtain lithium nickel manganese oxide doped with copper, titanium, nitrogen, and carbon.

First, a carbon source and the precursor of lithium nickel manganese oxide doped with copper and titanium are dry mixed by a three-dimensional mixer (model POETWQ M10), and secondary calcined in a tubular furnace to coat the carbon source on the surface of the aforementioned lithium nickel manganese oxide, thereby improving the specific discharge capacity of the powder. Here, the carbon source includes graphene, glucose, or a combination thereof.

Next, a nitrogen source is coated by a supercritical fluid extraction method to dope nitrogen with and modify the lithium nickel manganese oxide doped with copper and titanium and having the surface coated with the carbon material. For example, the nitrogen source is coated by the supercritical fluid extraction method, and dopamine and the precursor of lithium nickel manganese oxide doped with copper and titanium are added to a high-pressure reactor. The reaction temperature is 40° C. to 100° C., and carbon dioxide is used to increase the pressure to 50 atm to 100 atm for reaction for 8 hours so as to dope nitrogen with and modify the lithium nickel manganese oxide doped with copper and titanium and having the surface coated with the carbon material, and form a nitrogen-carbon-doped layer on the surface of the aforementioned lithium nickel manganese oxide, thereby further improving the conductivity and specific discharge capacity of the material. In addition, forming the nitrogen-doped carbon material on the surface of the aforementioned lithium nickel manganese oxide doped with copper and titanium may also increase active sites on the surface of the material to reduce the energy barrier encountered during ion penetration, which significantly facilitates the transfer of lithium ions and improves the effect of cycle testing. Here, the nitrogen source includes dopamine, p-phenylenediamine, or a combination thereof.

Furthermore, since the size of nitrogen is close to the size of carbon, nitrogen may replace part of the carbon to be filled on the surface of the lithium nickel manganese oxide to further increase the specific discharge capacity, but the disclosure is not limited thereto.

In addition, nitrogen doping is a modification technology for the carbon material. The principle is a chemical functionalization method that uses nitrogen to replace some of the carbon atoms in fullerenes, carbon nanotubes, graphene, or the like. Since nitrogen atoms have a size close to carbon, they are highly compatible, allowing nitrogen to be easily doped into the crystal lattice of the carbon material. In the N—C bond generated after doping, N atoms attract the electrons on adjacent C atoms, which induces electron defects to promote the conduction of electrons in the material. Therefore, doping nitrogen atoms on the surface of the carbon material may effectively enhance the conductivity and catalytic properties.

It should be noted that supercritical fluid extraction (SFE) is a technology used to separate and extract compounds, and usually uses a supercritical fluid as an extraction agent. The supercritical fluid is in a state of matter between a gas and a liquid, which has special physical and chemical properties that make it an effective extraction agent in certain situations. For example, under normal conditions, the supercritical fluid can reach a supercritical state by adjusting pressure and temperature. In such a state, the supercritical fluid may have the following characteristics: high diffusivity: the supercritical fluid has diffusion properties similar to a liquid, which allows the supercritical fluid to effectively penetrate and interact with compounds in a solid sample and allows the liquid to mix evenly with the solid sample; adjustability: the density and solubility of the supercritical fluid may be controlled by adjusting pressure and temperature, thereby adjusting the selectivity and efficiency of the extraction process; low surface tension: the supercritical fluid has lower surface tension than a liquid, which helps to better penetrate the solid sample; and reversibility: the supercritical fluid can quickly change states when the pressure and temperature are changed, allowing the extracted compounds to be easily separated from the supercritical fluid. The supercritical fluid extraction method may be widely used in different fields, including food, medicine, cosmetics, environmental analysis, etc., and may be used to extract natural products, remove impurities, separate compounds, and for other applications because the supercritical fluid extraction process eliminates the need for organic solvents and thereby reduces environmental impact and residues.

Hereinafter, the lithium nickel manganese oxide doped with copper, titanium, nitrogen, and carbon according to the disclosure will be described in detail with reference to examples. However, the following examples are not intended to limit the disclosure. Here, other unspecified components and specifications of the lithium battery may be obtained by those skilled in the art based on any content that is covered in the spirit and scope of the claims.

The positive material of Example 1 (lithium nickel manganese oxide doped with copper and titanium and modified with a nitrogen-doped carbon material)

41.83 g (0.168 mol) of nickel acetate (Ni(CH₃COO)₂ 4H₂O) and 10.38 g (0.06 mol) of manganese acetate (Mn(CH₃COO)₂) were dissolved in 228 ml of ethylenediamine according to the molar ratio of the elements of 1:2.8. The total concentration of metal ions was 1.0 M. 27.5 g (0.458 mol) of urea was added according to the molar ratio of urea to metal ions of 2:1, and stirred magnetically for 30 minutes. This mixed solution was stirred magnetically for 2 hours and then transferred to a high-pressure reactor, sealed for reaction at 80° C. to 170° C. for 10 hours, and cooled to the room temperature naturally. The obtained solution centrifugally precipitated (in a centrifuge at a rotation speed of 10,000 RPM), and the upper clear washing liquid was removed. The solution was alkaline. The precipitate was washed with water and dried in an oven at 120° C. After drying, a Ni_{0.25}Mn_{0.75}CO₃ precursor was obtained.

Next, the obtained Ni_{0.25}Mn_{0.75}CO₃ precursor was pre-calcinated at 400° C. to 700° C. for 3 hours, and then mechanically mixed with LiOH·H₂O according to Li:(Ni+Mn)=1.05:2 (molar ratio). After being mixed evenly, the obtained mixture was calcinated at 800° C. in the air for 12 hours, and then sintered for 10 hours at 800° C. to 1000° C. After natural cooling and grinding, the LiNi_{0.5}Mn_{1.5}O₄ positive material was obtained.

Then, copper acetate (7.2 grams) and titanium nitrate (8.4 grams) were added to the aforementioned lithium nickel manganate powder and mixed by a three-dimensional mixer to be evenly mixed. Next, the aforementioned material was mixed in a solvent (water) to prepare a 2M metal solution, and stirred to suspend the corresponding material. Then, a solvent was added at the ratio of 1:1 to the aforementioned material to precipitate the material based on the characteristics that the LiNi_{0.5}Mn_{1.5}O₄ precursor and the dopant are insoluble in the solvent (IPA, MEK, methanol, toluene), wherein the co-precipitation reaction temperature in the co-precipitation method was room temperature to 100° C., and the co-precipitation reaction time in the co-precipitation method was 30 minutes.

Next, a filtration process was performed to remove the solvent (for example, water) of the precursor of lithium nickel manganese oxide doped with copper and titanium and take out the solid part. A sintering process was performed to complete the lattice rearrangement, and copper and titanium were added to the lattice of nickel manganese oxide to obtain a precursor of lithium nickel manganese oxide doped with copper and titanium. Here, the sintering temperature was 400° C. to 1000° C., and the sintering time was 10 hours.

Then, the obtained product was mixed evenly with a water-soluble carbon-containing organic compound at a ratio of 100:10 to 20, and calcined at 600° C. for 2 to 3 hours under the protection of an inert gas to obtain carbon-coated lithium nickel manganese oxide. Next, a nitrogen source was coated by a supercritical fluid extraction method, and dopamine and the precursor of lithium nickel manganese oxide were added to a high-pressure reactor. The reaction temperature was 40° C. to 100° C. and the pressure was 50 atm to 100 atm for reaction for 8 hours so as to dope nitrogen with and modify the lithium nickel manganese oxide doped with copper and titanium and having the surface coated with the carbon material, and form a nitrogen-carbon-doped layer on the surface of the aforementioned lithium nickel manganese oxide.

### The Positive Material of Comparative Example 1 (Lithium Nickel Manganese Oxide Material)

41.83 g (0.168 mol) of nickel acetate (Ni(CH₃COO)₂·4H₂O) and 10.38 g (0.06 mol) of manganese acetate (Mn(CH₃COO)₂) were dissolved in 228 ml of ethylenediamine according to the molar ratio of the elements of 1:2.8. The total concentration of metal ions was 1.0 M. 27.5 g (0.458 mol) of urea was added according to the molar ratio of urea to metal ions of 2:1, and mixed by a three-dimensional mixer for 30 minutes. This mixed solution was stirred magnetically for 2 hours and then transferred to a high-pressure reactor, sealed for reaction at 80° C. to 170° C. for 10 hours, and cooled to the room temperature naturally. The obtained solution centrifugally precipitated (in a centrifuge at a rotation speed of 10,000 RPM), and the upper clear washing liquid was removed. The solution was alkaline. The precipitate was washed with water and dried in an oven at 120° C. After drying, a Ni_{0.25}Mn_{0.75}CO₃ precursor was obtained.

The obtained Ni_{0.25}Mn_{0.75}CO₃ precursor was pre-calcinated at 400° C. to 700° C. for 3 hours, and then mechanically mixed with LiOH·H₂O by a three-dimensional mixer according to Li:(Ni+Mn)=1.05:2 (molar ratio). After being mixed evenly, the obtained mixture was calcinated at 800° C. in the air for 12 hours, and then sintered for 10 hours at 800° C. to 1000° C. After natural cooling and grinding, the LiNi_{0.5}Mn_{1.5}O₄ positive material was obtained.

### The Positive Material of Comparative Example 2 (Lithium Nickel Manganese Oxide Doped with Copper and Titanium)

41.83 g (0.168 mol) of nickel acetate (Ni(CH₃COO)₂·4H₂O) and 10.38 g (0.06 mol) of manganese acetate (Mn(CH₃COO)₂) were dissolved in 228 ml of ethylenediamine according to the molar ratio of the elements of 1:2.8. The total concentration of metal ions was 1.0 M. 27.5 g (0.458 mol) of urea was added according to the molar ratio of urea to metal ions of 2:1. This mixed solution was stirred magnetically for 2 hours and then transferred to a high-pressure reactor, sealed for reaction at 80° C. to 170° C. for 10 hours, and cooled to the room temperature naturally. The obtained solution centrifugally precipitated (in a centrifuge at a rotation speed of 10,000 RPM), and the upper clear washing liquid was removed. The solution was alkaline. The precipitate was washed with water and dried in an oven at 120° C. After drying, a Ni_{0.25}Mn_{0.75}CO₃ precursor was obtained.

The obtained Ni_{0.25}Mn_{0.75}CO₃ precursor was pre-calcinated at 400° C. to 700° C. for 3 hours, and then mechanically mixed with LiOH·H₂O according to Li:(Ni+Mn)=1.05:2 (molar ratio). After being mixed evenly, the obtained mixture was calcinated at 800° C. in the air for 12 hours, and then sintered for 10 hours at 800° C. to 1000° C. After natural cooling and grinding, the LiNi_{0.5}Mn_{1.5}O₄ positive material was obtained.

Copper acetate (7.2 grams) and titanium nitrate (8.4 grams) were added to the aforementioned lithium nickel manganate powder and mixed by a three-dimensional mixer to be evenly mixed. Next, the aforementioned material was mixed in a solvent (water) to prepare a 2M metal solution, and stirred to suspend the corresponding material. Then, a solvent was added at the ratio of 1:1 to the aforementioned material to precipitate the material based on the characteristics that the LiNi_{0.5}Mn_{1.5}O₄ precursor and the dopant are insoluble in the solvent (IPA, MEK, methanol, toluene), wherein the co-precipitation reaction temperature in the co-precipitation method was room temperature to 100° C., and the co-precipitation reaction time in the co-precipitation method was 30 minutes.

Next, a filtration process was performed to remove the solvent (for example, water) of the precursor of lithium nickel manganese oxide doped with copper and titanium and take out the solid part. A sintering process was performed to complete the lattice rearrangement, and copper and titanium were added to the lattice of nickel manganese oxide to obtain a precursor of lithium nickel manganese oxide doped with copper and titanium. Here, the sintering temperature was 400° C. to 1000° C., and the sintering time was 10 hours.

### The Positive Material of Comparative Example 3 (Lithium Nickel Manganese Oxide Material Modified by Carbon Doping)

41.83 g (0.168 mol) of nickel acetate (Ni(CH₃COO)₂·4H₂O) and 10.38 g (0.06 mol) of manganese acetate (Mn(CH₃COO)₂) were dissolved in 228 ml of ethylenediamine according to the molar ratio of the elements of 1:2.8. The total concentration of metal ions was 1.0 M. 27.5 g (0.458 mol) of urea was added according to the molar ratio of urea to metal ions of 2:1. This mixed solution was stirred magnetically for 2 hours and then transferred to a high-pressure reactor, sealed for reaction at 80° C. to 170° C. for 10 hours, and cooled to the room temperature naturally. The obtained solution centrifugally precipitated (in a centrifuge at a rotation speed of 10,000 RPM), and the upper clear washing liquid was removed. The solution was alkaline. The precipitate was washed with water and dried in an oven at 120° C. After drying, a Ni_{0.25}Mn_{0.75}CO₃ precursor was obtained.

The obtained Ni_{0.25}Mn_{0.75}CO₃ precursor was pre-calcinated at 400° C. to 700° C. for 3 hours, and then mechanically mixed with LiOH·H₂O according to Li:(Ni+Mn)=1.05:2 (molar ratio). After being mixed evenly, the obtained mixture was calcinated at 800° C. in the air for 12 hours, and then sintered for 10 hours at 800° C. to 1000° C. After natural cooling and grinding, the LiNi_{0.5}Mn_{1.5}O₄ positive material was obtained.

Copper acetate (7.2 grams) and titanium nitrate (8.4 grams) were added to the aforementioned lithium nickel manganate powder and mixed by a three-dimensional mixer to be evenly mixed. Next, the aforementioned material was mixed in a solvent (water) to prepare a 2M metal solution, and stirred to suspend the corresponding material. Then, a solvent was added at the ratio of 1:1 to the aforementioned material to precipitate the material based on the characteristics that the LiNi_{0.5}Mn_{1.5}O₄ precursor and the dopant are insoluble in the solvent (IPA, MEK, methanol, toluene), wherein the co-precipitation reaction temperature in the co-precipitation method was room temperature to 100° C., and the co-precipitation reaction time in the co-precipitation method was 30 minutes.

Next, a filtration process was performed to remove the solvent (for example, water) of the precursor of lithium nickel manganese oxide doped with copper and titanium and take out the solid part. A sintering process was performed to complete the lattice rearrangement, and copper and titanium were added to the lattice of nickel manganese oxide to obtain a precursor of lithium nickel manganese oxide doped with copper and titanium. Here, the sintering temperature was 400° C. to 1000° C., and the sintering time was 10 hours. Then, the obtained product was mixed evenly with a water-soluble carbon-containing organic compound at a weight ratio of 100:1 to 20 (preferably 7 to 12), and roasted at 600° C. for 2 to 3 hours under the protection of an inert gas to obtain carbon-coated lithium nickel manganese oxide.

### The Positive Material of Comparative Example 4 (Lithium Nickel Manganese Oxide Material Modified with Nitrogen-Doped Carbon Material)

41.83 g (0.168 mol) of nickel acetate (Ni(CH₃COO)₂·4H₂O) and 10.38 g (0.06 mol) of manganese acetate (Mn(CH₃COO)₂) were dissolved in 228 ml of ethylenediamine according to the molar ratio of the elements of 1:2.8. The total concentration of metal ions was 1.0 M. 27.5 g (0.458 mol) of urea was added according to the molar ratio of urea to metal ions of 2:1. This mixed solution was stirred magnetically for 2 hours and then transferred to a high-pressure reactor, sealed for reaction at 80° C. to 170° C. for 10 hours, and cooled to the room temperature naturally. The obtained solution centrifugally precipitated (in a centrifuge at a rotation speed of 10,000 RPM), and the upper clear washing liquid was removed. The solution was alkaline. The precipitate was washed with water and dried in an oven at 120° C. After drying, a Ni_{0.25}Mn_{0.75}CO₃ precursor was obtained.

The obtained Ni_{0.25}Mn_{0.75}CO₃ precursor was pre-calcinated at 400° C. to 700° C. for 3 hours, and then mechanically mixed with LiOH·H₂O according to Li:(Ni+Mn)=1.05:2 (molar ratio). After being mixed evenly, the obtained mixture was calcinated at 800° C. in the air for 12 hours, and then sintered for 10 hours at 800° C. to 1000° C. After natural cooling and grinding, the LiNi_{0.5}Mn_{1.5}O₄ positive material was obtained.

The obtained product was mixed evenly with a water-soluble carbon-containing organic compound at a weight ratio of 100:10 to 20, and roasted at 600° C. for 2 to 3 hours under the protection of an inert gas to obtain carbon-coated lithium nickel manganese oxide. Next, a nitrogen source was coated by a supercritical fluid extraction method, and dopamine and the precursor of lithium nickel manganese oxide were added to a high-pressure reactor. The reaction temperature was 40° C. to 100° C., and carbon dioxide was introduced to adjust the pressure to 50 atm to 100 atm for reaction for 8 hours so as to dope nitrogen with and modify the lithium nickel manganese oxide having the surface coated with the carbon material, and form a nitrogen-carbon-doped layer on the surface of the aforementioned lithium nickel manganese oxide.

### Preparation of a Lithium Battery

First, the positive material of the Example and conductive carbon black (Super P) were placed in an oven at 120° C. for 1 hour to remove moisture. Next, 80 parts by weight of the positive material of the Example, 10 parts by weight of the conductive carbon black (Super P), and 10 parts by weight of an adhesive (PVDF (HSV-900)) were mixed evenly in a solvent (NMP) to prepare a uniform positive slurry. Then, the positive slurry was applied to aluminum foil with a scraper. The wet film thickness was 200 μm and the applying speed was 2 mm/s. The aluminum foil was moved into an oven and dried at 60° C. to 120° C., and then calendered to a thickness of 0.038 mm. The calendered positive electrode piece was cut into a circular electrode piece with a diameter of 13 mm.

Thereafter, a CR2032 button battery pack was prepared. First, a negative electrode (metal lithium sheet) lower cover was placed on an insulating platform, a metal lithium sheet having a diameter of 15.8 mm was placed in the center of the negative electrode lower cover, and a tablet machine was used to flatten the lithium sheet. Then, an appropriate amount of liquid electrolyte (1M LiPF₆ in EC: December 1:1 v/v %) was dropped on a commercially available isolation membrane (trade name: Celgard 2400) having a diameter of 18 mm. The isolation membrane was put on top of the lithium sheet, and the positive electrode prepared according to the method described above, a spacer, a reed, and a positive electrode upper cover were added sequentially. Next, insulating tweezers were used to place the button-type lithium battery into a battery press with the negative electrode facing upward, which was pressed with a pressure of 800 Pa to complete the assembly of the battery.

### Comparative Examples

Button-type lithium batteries were prepared in the same manner as in the Example, except that the positive materials of the Comparative Examples prepared as above were used instead of the positive material of the Example.

### Analysis of Electrochemical Characteristics

### Initial Discharge Capacity and Capacity Decay Rate

The discharge specific discharge capacity of the button-type lithium batteries of Example 1 and Comparative Examples 1 to 4 at 0.5C and 25° C. are shown in Table 1. The formula for calculating the capacity of charging and discharging of different positive materials is as follows: specific discharge capacity (mAh/g)=(current (mA)×time (h))/(mass of active material (the positive material of the Example/the Comparative Examples) (g)).

TABLE 1

| | | Compara- | Compara- | Compara- | Compara- |
|---|---|---|---|---|---|
| | | tive | tive | tive | tive |
| | Example 1 | Example 1 | Example 2 | Example 3 | Example 4 |
| specific | 136 | 113 | 120 | 126 | 130 |
| discharge | | | | | |
| capacity | | | | | |
| (mAh/g) | | | | | |

In summary, at least one embodiment of the disclosure improves the energy density of the lithium nickel manganese oxide material and solves the problem of low specific discharge capacity with copper-titanium-nitrogen-carbon doping technology. Therefore, the lithium battery positive material of the disclosure effectively increases the specific discharge capacity and thereby reduces the costs.

Although the disclosure has been disclosed with reference to the embodiments above, the embodiments are not intended to limit the disclosure. Anyone having ordinary knowledge in the art may make changes and modifications without departing from the spirit and scope of the disclosure. Therefore, the scope of protection of the disclosure shall be defined by the following claims.

What is claimed is:

1. A lithium battery positive material, comprising lithium nickel manganese oxide doped with copper, titanium, nitrogen, and carbon.

2. The lithium battery positive material according to claim 1, wherein a weight ratio of lithium nickel manganese oxide: copper/titanium: nitrogen/carbon in the lithium nickel manganese oxide doped with copper, titanium, nitrogen, and carbon ranges from 1:0.4:0.1 to 1:0.1:0.1.

3. The lithium battery positive material according to claim 1, wherein an average particle size of the lithium nickel manganese oxide doped with copper, titanium, nitrogen, and carbon is 0.5 microns to 20 microns.

4. A manufacturing method for manufacturing a lithium battery positive material, the manufacturing method comprising:
using a copper source, a titanium source, and lithium nickel manganate powder to form a precursor of lithium nickel manganese oxide doped with copper and titanium by performing a co-precipitation method, a filtration process, and a sintering process; and
mixing the precursor of the lithium nickel manganese oxide doped with copper and titanium with a carbon source, and coating a nitrogen source by a supercritical fluid extraction method to obtain the lithium nickel manganese oxide doped with copper, titanium, nitrogen, and carbon.

5. The manufacturing method for manufacturing the lithium battery positive material according to claim 4, wherein the copper source comprises copper chloride, copper sulfate, copper sulfite, copper nitrate, copper acetate, or a combination thereof.

6. The manufacturing method for manufacturing the lithium battery positive material according to claim 4, wherein the titanium source comprises titanium chloride, titanium sulfate, titanium nitrate, or a combination thereof.

7. The manufacturing method for manufacturing the lithium battery positive material according to claim 4, wherein the nitrogen source comprises dopamine, p-phenylenediamine, or a combination thereof.

8. The manufacturing method for manufacturing the lithium battery positive material according to claim 4, wherein the carbon source comprises graphene, glucose, or a combination thereof.

9. The manufacturing method for manufacturing the lithium battery positive material according to claim 4, wherein a co-precipitation agent used in the co-precipitation method comprises water, ethanol, isopropyl alcohol, acetone, methyl ethyl ketone, ammonia, sodium hydroxide, sodium carbonate, or a combination thereof; a co-precipitation reaction temperature in the co-precipitation method ranges from 25° C. to 100° C., and a co-precipitation reaction time in the co-precipitation method ranges from 1 minute to 30 minutes.

10. The manufacturing method for manufacturing the lithium battery positive material according to claim 4, wherein a temperature of the sintering process ranges from 400° C. to 1000° C.
